(19) United States
(12) Patent Application Publication
(10) Pub. No.: US 2006/0094824 A1
(43) Pub. Date: May 4, 2006

(54) Polymer composition having elastomeric features

(76) Inventors: Jacques Roulin, Vesenaz (CH); Bernard Rioux, Puteaux (FR)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/204,426

(22) Filed: Aug. 16, 2005

Related U.S. Application Data
(63) Continuation of application No. 60/624,293, filed on Nov. 2, 2004.

(51) Int. Cl. C08L 33/04; C08L 35/02

(52) U.S. Cl. 525/222

(57) ABSTRACT

Polymer compositions having elastomeric features, such as an extended elastic domain, are provided. The polymer compositions of the invention, which are useful in packaging materials, for example pallet stretch hoods, comprise a polyolefin; an ethylene vinyl acetate copolymer, an ethylene methyl acrylate copolymer, or a combination of ethylene vinyl acetate copolymer and a ethylene methyl acrylate copolymer; a metallocene catalyzed polyethylene; and, optionally, an ethylene acid copolymer.

This application claims the benefit of U.S. Provisional Application No. 60/624,293, filed Nov. 2, 2004.

### FIELD OF THE INVENTION

The present invention relates to the field of polymer compositions having elastomeric features, and in particular to polymer compositions with an extended elastic domain. The polymer compositions of the invention are useful in packaging materials, and specifically in pallet stretch hoods.

### BACKGROUND OF THE INVENTION

Several patents and publications are cited in this description in order to more fully describe the state of the art to which this invention pertains. The entire disclosure of each of these patents and publications is incorporated by reference herein.

The efficiency of the global economy depends in part on the ability to transport goods throughout the world. Shipping expenses are a significant component of the cost of most goods. Therefore, any practical means of reducing shipping expenses will promote economic efficiency and will benefit both manufacturers and consumers.

Many relatively small items are shipped on pallets, that is, platforms that are easily moved by forklifts or small cranes. Pallets provide convenience in loading and unloading goods from shipping containers, and in moving smaller amounts of goods over shorter distances, such as within warehouses, or to deliver a retail quantity. The small items may be unpackaged or packaged, for example in bags or boxes, when they are placed on the pallets.

A loaded pallet must have integrity and stability, so that the goods are not damaged or lost during shipping. To provide the necessary integrity and stability, the pallet and its load are typically wrapped together in film, for example overlapping layers of polyethylene stretch wrap, that may be applied by machine or by hand. See, e.g., U.S. Pat. No. RE38,429, issued to Eichbauer. Other generally practiced methods of providing integrity and stability to loaded pallets include wrapping the pallet and its load in heat shrinkable film, encasing the loaded pallet in a heat shrinkable sheath or “hood”, and containing the goods in a single carton box. These methods are sometimes referred to, individually or collectively, as “pallet unitizing.”

Each of these pallet unitizing methods suffers from one or more disadvantages. Paper or cardboard-based carton boxes are costly, and they are insufficiently resistant to damage from water, dust, punctures, and other insults to which loaded pallets are typically subject during shipping. Polyethylene stretch wrap is difficult to slit open. Overlapping layers of film, whether stretch film or heat shrinkable film, also provide insufficient resistance to water damage. Heat shrinkable films and hoods are economically unattractive due to high raw material costs. Moreover, heat shrinking requires a significant capital investment in a heating apparatus, and presents serious safety issues in connection with the heating itself.

In addition, the cycle time of wrapping a loaded pallet with a linear stretch wrapping film is inefficiently long. This is the case when the film is applied by a machine, for example when the loaded pallet is placed on a turntable and rotated as the film is fed horizontally and its position is varied vertically to wrap the loaded pallet in overlapping layers. The disadvantageously long cycle time is all the more pronounced when the film is applied manually, as by an operator with a hand-held film dispenser who walks around the loaded pallet until a sufficient amount of film is applied. In the case of heat shrinkable films, the cycle time and energy costs of the heat shrinking process create an even greater economic disadvantage.

Whether the stretch wrapping film is applied to the loaded pallet by machine or manually, the end of the film must be secured to the wrapped, loaded pallet in a separate step, typically by an adhesive. Moreover, the overlapping layers of film represent wasted packaging material, the cost of which could be recovered in a more efficient procedure.

Pallet stretch hoods (“PSH”) are an alternative to the packaging methods described above. Pallet stretch hoods are elastic sheaths that are stretched to fit over a pallet and its load. The pallet stretch hood then contracts, due to its elastic properties, and the forces of contraction provide integrity and stability to the loaded pallet.

Pallet stretch hoods offer numerous practical and economic advantages over the most common methods of wrapping or containing loaded pallets. For example, the cycle time of applying a stretch hood to a pallet is significantly shorter than the cycle time of wrapping a loaded pallet with a linear film. Also, no adhesive is required to secure the pallet stretch hood. Furthermore, pallet stretch hoods are economically favorable when compared to cardboard cartons. The integral structure of the sheath also provides good protection from dust, water, and like insults to the loaded pallet during shipping. The protection against water damage provided by pallet stretch hoods is generally sufficient to make outdoor storage of loaded pallets feasible. In addition, the integral structure of the pallet stretch hoods reduces the waste of material resulting form overlapping layers of linear film packaging. Moreover, the elastic properties of the pallet stretch hood enable it to stabilize goods of a wide variety of shapes. In brief, pallet stretch hoods provide better protection for goods in shipment at a lower cost than comparable pallet unitizing methods.

The pallet stretch hoods known in the art, however, are usually made from elastomeric polymers such as copolymers of ethylene and vinyl acetate, or blends of ethylene vinyl acetate copolymers with polyethylene. Disadvantageously, however, these materials do not have a sufficiently broad elastic domain. Consequently, the elastic recovery of the pallet stretch hoods made from these materials may be inadequate after the pallet stretch hoods have been stretched to cover the loaded pallets. An insufficient elastic recovery can lead to a deficiency in the force with which the pallet stretch hoods secures the goods to each other and to the pallet. As a result, the integrity and stability of the hooded, loaded pallet are decreased, and damage or loss of the goods becomes more likely.

In summary, when shipping goods on pallets, it is desirable to use a packaging material, typically a form of container or overwrapping, to provide the loaded pallets with integrity and stability. The packaging material should provide adequate resistance to water, dust, punctures, and similar insults. It is also desirable for the loaded pallets to arrive in good condition, and to be easily opened on arrival. Because of these requirements, it will be appreciated that an ongoing need exists for a means of preserving the stability and integrity of loaded pallets that is economically attractive, provides resistance to insults that are typical of shipping conditions, and is easily opened. It will also be appreciated that there is an ongoing need for improvements in the technology of pallet stretch hoods.

### SUMMARY OF THE INVENTION

A new polymer composition that has elastomeric features and, when used in a packaging material, offers improved integrity and stability to its contents by virtue of its extended elastic domain, has now been found in the present invention. The polymer composition of the invention is economically attractive, easily processed, and, when used in a packaging material, provides effective resistance to damage from water, dust, punctures, and other insults of shipping, so that the contents will arrive in good condition. Packaging materials including the polymer composition of the invention are also easily opened.

The polymer compositions of the invention are particularly suited to be used in pallet stretch hoods, owing to their extended elastic domain. Furthermore, pallet stretch hoods including the polymer composition of the invention provide improved properties over pallet stretch hoods known in the art to date, including a broader elastic domain, resulting in increased forces securing the goods on a loaded pallet to each other and to the pallet, and a more rapid development of those forces.

Accordingly, in a first aspect, the present invention provides a polymer composition comprising a polyolefin; a copolymer of ethylene and vinyl acetate (EVA), a copolymer of ethylene and methyl acrylate (EMA), or a combination of an ethylene vinyl acrylate copolymer and an ethylene methyl acrylate copolymer; a metallocene catalyzed polyolefin (mPE); and, optionally, an acid copolymer. The polymer composition of the invention is characterized by one or more elastomeric features.

In accordance with another aspect of the invention, a method of increasing the elastic domain of a polymer blend is provided. In this method, a polyolefin is blended with an ethylene vinyl acrylate copolymer, an ethylene methyl acrylate copolymer, or a combination of an ethylene vinyl acrylate copolymer and an ethylene methyl acrylate copolymer, and, optionally, an acid copolymer.

In accordance with another aspect of the invention, an object comprising the polymer composition of the invention is provided.

In accordance with another aspect of the invention, a pallet stretch hood comprising the polymer composition of the invention is provided.

### DETAILED DESCRIPTION OF THE INVENTION

The following definitions apply to the terms as used throughout this specification, unless otherwise limited in specific instances.

The term “copolymer”, as used herein, alone or in combined form, e.g., “copolymeric” or “copolymerized”, refers to polymers derived from two or more monomers.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The term “ethylene polymer”, as used herein, refers to any polymer comprising greater than fifty mole percent of —CH₂CH₂— repeating units derived from an ethylene monomer or comonomer.

The term “elastomeric features”, as used herein, refers to the property of a material recovering, in whole or in part, one or more of its original dimensions upon removal of a deforming force and continuing to exert a force to recover one or more of its original dimensions if complete recovery is prevented by an opposing force.

The terms “finite amount” and “finite value”, as used herein, refer to an amount that is not equal to zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

In one embodiment, the present invention provides a polymer composition comprising a polyolefin; a copolymer of ethylene and vinyl acetate, a copolymer of ethylene and methyl acrylate, or a combination of an ethylene vinyl acrylate copolymer and an ethylene methyl acrylate copolymer; a metallocene catalyzed polyethylene; and, optionally, an acid copolymer, provided that the acid copolymer is present in a finite amount when the composition does not include an ethylene methyl acrylate copolymer. The polymer composition of the invention is characterized by one or more elastomeric features.

The polymer compositions of the invention include a polyolefin. Polyolefins suitable for use in the present invention may be homopolymers or copolymers of two or more monomers. Suitable polyolefin molecules may be straight chained, branched, or grafted. The MFI of a suitable polyolefin, measured according to ASTM D1238, may range up to about 10 g/10 min. More suitably, and in order of increasing preference, the MFI may range up to about 2.5 g/10 min, about 1.0 g/10 min, about 0.5 g/10 min, or about 0.3 g/10 min.

Ethylene polymers are more preferred polyolefins for use in the present invention. Ethylene polymers include any ethylene containing polymers within the definition set forth above, whether homopolymers or copolymers. Examples of ethylene polymers include, but are not limited to, ethylene homopolymers and ethylene interpolymers, such as low density polyethylene (LDPE), heterogeneously branched ethylene/α-olefin interpolymer, e.g., linear low density polyethylene (LLDPE), ultra low density polyethylene (ULDPE), substantially linear ethylene polymers (SLEP), and homogeneously branched ethylene polymers.

Unsaturated comonomers useful for polymerizing with ethylene to form ethylene polymers suitable for use in the invention include, for example, ethylenically unsaturated monomers, conjugated or non-conjugated dienes, polyenes, and the like. Examples of suitable comonomers include, without limitation, straight-chained or branched C₃ to C₂₀ α-olefins such as propylene, isobutylene, 1-butene, 1-hexene, 1-pentene, 4-methyl-1-pentene, 1-heptene, 1-octene, 1-nonene, 1-decene, styrene, halo- or alkyl-substituted styrenes, tetrafluoroethylene, vinylbenzocyclobutane, 1,4-hexadiene, 1,7-octadiene; and cycloalkenes, e.g., cyclopentene, cyclohexene and cyclooctene; and the like.

Preferred ethylene comonomers for use in the present invention include propylene, 1-butene, 1-pentene, 1-hexene, 4-methyl-1-pentene, 1-heptene, and 1-octene.

Several preferred polyolefins for use in the present invention are commercially available. These include LDPE 2100, available from SABIC Deutschland GmbH of Düsseldorf, Germany.

Methods of preparing polyolefins are well known in the art. See, for example, the Modern Plastics Encyclopedia, McGraw Hill, (New York, 1994) or the Wiley Encyclopedia of Packaging Technology, 2d edition, A. L. Brody and K. S. Marsh, Eds., Wiley-lnterscience (Hoboken, 1997).

The polymer compositions of the present invention may also include a copolymer of ethylene and vinyl acetate. Any known ethylene vinyl acetate (EVA) copolymer whose melting point is greater than about 80° C. is suitable for use in the present invention. For example, the Modern Plastics Encyclopedia describes various EVA copolymers and uses thereof.

Those of skill in the art are aware that there is an optimal range of vinyl acetate comonomer levels in EVA copolymers that varies depending upon the physical properties that are desirable in the application of interest. For example, EVA copolymers containing high levels of vinyl acetate comonomer are often too sticky for use in the present invention. In addition, EVA copolymers having low levels of vinyl acetate comonomer are typically characterized by insufficient elastomeric properties for use in the present invention. Preferably, therefore, the ethylene vinyl acetate copolymers include about 10 wt % to about 25 wt % of vinyl acetate residues. More preferably, the ethylene vinyl acetate copolymers include about 12 wt % to about 18 wt % of vinyl acetate residues.

The melt flow index (MFI) of the EVA copolymers, as measured by ASTM D1238, may range from 0.1 g/10 min up to about 10 g/10 min or about 15 g/10 min; however, as those of skill in the art are aware, a large discrepancy between the MFI of the EVA copolymer and the MFI of the polyolefin will result in an undesirable phase separation. Accordingly, the MFI of the EVA copolymer is preferably between about 0.3 g/10 min and about 1 g/10 min. In increasing order of preference, the MFI may be less than about 2.5 g/10 min, about 2.0 g/10 min, about 1.0 g/10 min, about 0.7 g/10 min, or about 0.3 g/10 min.

Several preferred EVA copolymers for use in the present invention are commercially available. These include Elvax® copolymers, available from DuPont.

Methods of preparing EVA copolymers are well known in the art. See, for example, the Modern Plastics Encyclopedia and the Wiley Encyclopedia of Packaging Technology.

The polymer compositions of the present invention may also include a copolymer of ethylene and methyl acrylate, in combination with or as a substitute for the EVA. Any known ethylene methyl acrylate (E MA) copolymer is suitable for use in the present invention. For example, U.S. Patent Appln. Pub. No. 2004/0006180 describes various EMA copolymers and uses thereof.

Preferred EMA copolymers include those that are prepared in a tubular reactor. Also preferably, the methyl acrylate comonomer content is greater than about 10 wt %, based on the weight of the EMA copolymer. More preferably, the methyl acrylate comonomer content is greater than about 15 wt %, and, still more preferably, the methyl acrylate comonomer content is greater than about 25 wt %, based on the weight of the EMA copolymer.

The melt flow index (MFI) of the EMA copolymers, as measured by ASTM D1238, may range up to about 10 g/10 min or about 15 g/10 min; however, as those of skill in the art are aware, a large discrepancy between the MFI of the EMA copolymer and the MFI of the polyolefin will result in an undesirable phase separation. Accordingly, the MFI of the EMA copolymer is preferably less than about 2.0 g/10 min to about 2.5 g/10 min, more preferably less than about 1.0 g/10 min, and still more preferably less than about 0.7 g/10 min.

Several preferred EMA copolymers for use in the present invention are commercially available. These include Elvaloy® AC polymers, available from DuPont.

Methods of preparing EMA copolymers are well known in the art. See, for example, the Modern Plastics Encyclopedia and the Wiley Encyclopedia of Packaging Technology.

The polymer compositions of the invention also include a metallocene catalyzed polyethylene (mPE). Any known mPE may be used in the present invention. Suitable mPEs may be homopolymers or copolymers of two or more monomers. The mPE molecules may be straight chained, branched, or grafted. The MFI of a suitable metallocene catalyzed polyethylene, measured according to ASTM D1238, may range up to about 10 g/10 min. More suitably, and in order of increasing preference, the MFI may range up to about 2.5 g/10 min, about 1.0 g/10 min, about 0.5 g/10 min, or about 0.3 g/10 min.

Several preferred metallocene catalyzed polyolefins for use in the present invention are commercially available. These include Engage® polyolefins, available from DuPont Dow Elastomers, L.L.C., of Wilmington, Del., and Exceed™ polyethylenes available from ExxonMobil Chemical CO. of Houston, Tex.

Methods of preparing metallocene catalyzed polyethylenes are well known in the art. See, for example, the Modern Plastics Encyclopedia, the Wiley Encyclopedia of Packaging Technology, and U.S. Pat. Nos. 5,278,272; 5,198,401; and 5,405,922.

The polymer compositions of the invention also include an acid copolymer, when the amount of EMA is zero. Suitable acid copolymers for use in the present invention are preferably “direct” acid copolymers. They are preferably copolymers of an alpha olefin, more preferably ethylene, with a C₃ to C₈, α,β ethylenically unsaturated carboxylic acid, more preferably (meth)acrylic acid.

The acid copolymers may optionally contain a third, softening monomer. The term “softening”, as used in this context, refers to a disruption of the crystallinity of the copolymer. Preferred “softening” comonomers are include, for example, alkyl (meth)acrylates wherein the alkyl groups have from about 1 to about 8 carbon atoms.

The acid copolymers, when the alpha olefin is ethylene, can be described as E/X/Y copolymers, wherein E is ethylene, X is the α,β ethylenically unsaturated carboxylic acid, and Y is a softening comonomer. X is preferably present at a level of about 3 to about 30 wt %, preferably about 4 to about 25 wt %, and more preferably about 5 to about 20 wt % of the acid copolymer. Y is preferably present at a level of about 0 to about 30 wt % of the acid copolymer. Alternatively, Y may be present at a level of about 3 to about 25 wt % or about 10 to about 23 wt % of the acid copolymer.

Examples of acid copolymers suitable for use in the present invention include ethylene/(meth)acrylic acid copolymers. Also included are ethylene/(meth)acrylic acid/n-butyl(meth)acrylate, ethylene/(meth)acrylic acid/iso-butyl(meth)acrylate, ethylene/(meth)acrylic acid/methyl(meth)acrylate, and ethylene/(meth)acrylic acid/ethyl(meth)acrylate terpolymers.

Several preferred acid copolymers for use in the present invention are commercially available. These include Nucrel® polymers, available from E. I. du Pont de Nemours and Co. of Wilmington, Del. (DuPont), and Escor™ polymers, available from ExxonMobil Chemical Company of Houston, Tex., and the like.

Methods of preparing acid copolymers of ethylene are well known in the art. For example, acid copolymers may be prepared by the method disclosed in U.S. Pat. No. 4,351,931, issued to Armitage. This patent describes acid copolymers of ethylene comprising up to 90 weight percent ethylene. In addition, U.S. Pat. No. 5,028,674, issued to Hatch et al., discloses improved methods of synthesizing acid copolymers of ethylene when polar comonomers such as (meth)acrylic acid are incorporated into the copolymer, particularly at levels higher than 10 weight percent. Finally, U.S. Pat. No. 4,248,990, issued to Pieski, describes the preparation and properties of acid copolymers synthesized at low polymerization temperatures and normal pressures.

Ethylene-acid copolymers with high levels of acid (X) are difficult to prepare in continuous polymerizers because of monomer-polymer phase separation. This difficulty can be avoided however by use of “co-solvent technology” as described in U.S. Pat. No. 5,028,674, or by employing somewhat higher pressures than those at which copolymers with lower acid can be prepared.

The polyolefin is present in the polymer compositions of the invention in a finite amount up to about 80 wt %, based on the total weight of the polymer composition. Preferably, the polymer compositions include about 20 to about 70 wt %, and more preferably about 40 to about 60 wt %, of the polyolefin.

The polymer compositions of the invention comprise a finite amount up to about 80 wt %, based on the total weight of the polymer composition, of EVA copolymer, EMA copolymer, or a combination of EVA and EMA copolymers. Preferably, the polymer compositions include about 20 to about 70 wt %, and more preferably about 40 to about 60 wt %, of the EVA copolymer EMA copolymer, or combination of EVA copolymer and EMA copolymer. The ratio of the amount of EVA copolymer to the amount of EMA copolymer, when both are present, may be any non-zero real number.

The mPE is present in the polymer compositions of the invention in a finite amount up to about 30 wt %, based on the total weight of the polymer composition. Preferably, the polymer compositions include about 5 to about 20 wt %, and more preferably about 5 to about 15 wt %, of the mPE.

When the polymer compositions of the present invention comprise an acid copolymer, it is preferably present in a finite amount up to about 30 wt %, based on the total weight of the polymer composition, of acid copolymer. Preferably, the polymer compositions include about 5 to about 20 wt %, and more preferably about 5 to about 15 wt %, of the acid copolymer.

The polymer composition of the present invention may also include such additives as are commonly used in elastomeric polymer compositions that are known in the art. Such additives include, but are not limited to, slip enhancers and antiblock agents as are known in the art for use in pallet stretch hoods. Suitable levels of these additives and methods of incorporating additives into polymer compositions are also known to those of skill in the art. See, for example, the Modern Plastics Encyclopedia or the Wiley Encyclopedia of Packaging Technology, complete bibliographic information for both of which is cited in full above.

To form the polymer composition of the invention, the individual components may be blended by any suitable means known in the art. For example, the individual materials can be mixed with each other in molten form, such as by melt blending in an extruder. Alternatively, the individual materials can be blended with each other in a high shear mixing device, such as a twin screw extruder, or an extruder coupled with a blown film line.

Those of skill in the art are well aware of the methods of making polymer blends. Furthermore, it will be apparent to those of skill in the art that a three or four polymer blend may be produced by directly blending the three or four component polymers, and that it may also be produced by pre-blending two or more of the component polymers prior to blending in the remaining components.

The polymer compositions of the invention are characterized by certain elastomeric features including, but not limited to, an increased elastomeric domain. Broadly, the elastic domain is considered to be increased when, in a stress relaxation test, a material can withstand higher strain, that is, greater deformation forces, while keeping a stable modulus, i.e., stress/strain ratio. With respect to the present invention, an increased elastic domain may be manifested as the ability of a material to maintain a higher portion of its initial tension after an initial strong elongation has been reduced. Alternatively, an increased elastic domain may be measured as a relative reduction in the time required for a material to recover its original length, or an intermediate equilibrium length, after a strong elongation has been exerted and relaxed.

The present invention also provides objects comprising the polymer composition of the invention. Objects according to the invention may be made according to methods that are well known in the art. For example, after mixing the components of the polymer composition in an extruder, the polymer composition is a fluid that may be shaped by injection molding, casting, melt extrusion, flat die extrusion, blown film extrusion or any other conventional technique that will produce the desired shape. The polymer composition may also be formed into fibers and/or filaments by methods well known in the art, for example by dry spinning. When solidified, the polymer composition may be shaped by cutting, grinding, milling, carving, and the like.

Preferably, the polymer compositions of the present invention are used to make pallet stretch hoods. It is to be understood, however, that the objects and methods described herein are considered to be within the scope of the invention, whether they relate to pallet stretch hoods, or to other uses of the polymer composition of the invention. The polymer compositions of the invention will be useful in any object requiring elastomeric features, for example, in the stretch wrapping films that are described above.

Pallet stretch hoods according to the invention may be made by traditional coextrusion blown film processes.

Pallet stretch hoods including the polymer composition of the invention offer numerous advantages resulting from the broader elastic domain of the polymer composition of the invention. These advantages include a faster recovery towards original dimensions after the pallet stretch hood is stretched to cover the goods on a pallet. This is a key property for the efficiency of the pallet stretch hood process, which, as noted above, depends in part on minimizing the cycle time to secure the goods to the pallet.

In addition, pallet stretch hoods of the invention provide better retention of cohesive forces securing the goods on a loaded pallet to each other and to the pallet, after the initial stretch tension to open the pallet stretch hood has been released. Also advantageously, pallet stretch hoods of the invention are better able to recover from forces exerted by goods that have shifted in transit, thus reducing spillage of goods from pallets that are in transit.

The polymer composition of the invention also offers improved resistance to tears and punctures. In pallet stretch hoods, this property is useful to reduce spillage of goods from pallets due to physical insults suffered in transit.

In accordance with another aspect of the invention, a method of increasing the elastic domain of a polymer blend is provided. In the method of the invention, a polyolefin is blended with an ethylene vinyl acetate copolymer, an ethylene methyl acrylate copolymer, or a combination of ethylene vinyl acetate copolymer and ethylene methyl acrylate copolymer; a metallocene catalyzed polyethylene; and, optionally, an acid copolymer. The resulting polymer blend has an elastic domain that is greater than that of a blend consisting essentially of the polyolefin and the EVA and/or EMA copolymer(s).

The following examples are provided to describe the invention in further detail. These examples, which set forth a preferred mode presently contemplated for carrying out the invention, are intended to illustrate and not to limit the invention.

### EXAMPLES

The polymer compositions in the following examples were prepared by blending the dry ingredients together, and subsequently extruding as a monolayer film in a Brabender™ extrusion blown film die so as to form a monolayer film with a total thickness of 100 microns. The die temperature was 210° C. The blow-up ratio of the blown film, defined as the stabilized film bubble diameter divided by the diameter of the die opening, was 2.9. The die gap was set at 0.42 mm. The film was run at 5.5 m/min through the take-up rolls.

The composition of each of the test films is listed in Table 1, below.

TABLE 1
Compositions

| Example No. | Wt % Polyolefin | EMA | Wt % EMA | Wt % mPE |
|---|---|---|---|---|
| Comparative 1 | 50 | A | 50 | 0 |
| Comparative 2 | 50 | B | 50 | 0 |
| 1 | 50 | A | 40 | 10 |
| 2 | 60 | B | 33 | 7 |

Notes for Table 1:
The polyolefin is LDPE 2100.
The EMA(A) copolymer is Elvaloy ® AC XP 1335.
The EMA(B) copolymer is Elvaloy ® AC XP 3135.
The mPE is Engage ® 8180.

The physical properties of each of the films was measured according to the following methods:

The Spencer impact value is the energy in J/mm necessary to puncture a film with a probe of standard size and shape. The results presented herein were measured on representative film samples, free of imperfections, that were conditioned (24 h at 23° C. and 50% relative humidity) before testing on an Elmendorf tear tester with a calibrated Spencer impact tester attachment, according to ASTM D 3420-95.

The coefficient of friction (COF) was measured on a tensile tester by moving a sled over a stationary plane of film, according to ASTM D 1894-90. A sled weighing 200 g was moved at a speed of 152 mm/min in the machine direction over a distance of 130 mm.

To measure the elastic properties of the films, a sample (0.5 m²) of each test film was placed in the jaws of a Zwick 2.5 tensile tester, whose grips were set 100 mm apart. With the jaws moving apart at a rate of 13 mm/sec, the samples were stretched, in separate runs, to lengths that were 90%, 100%, 110%, and 120% longer than the original, relaxed lengths of the samples. The force on the films was then immediately released, and they were held at 130% of their original, relaxed length. The maximum force required to stretch each film was recorded as the “Fε Total”, and the force exerted by each sample when equilibrated at 130% elongation after 40 to 60 seconds was recorded as the “Force Reference Value, lower dwell time”.

The results of these measurements are summarized in Tables 2 and 3, below.

TABLE 2
Spencer Impact Data

| Example No. | Spencer Impact J/mm | COF |
|---|---|---|
| Comparative 1 | 19.6 | n/a |
| Comparative 2 | 21 | n/a |
| 1 | 40.6 | 1.43 |
| 2 | 33.8 | 0.142 |

Note:
“n/a” means “not available.”

Table 2 sets forth the Spencer impact measurements, which demonstrate that the force required to pierce the film of Examples 1 and 2 was significantly greater than the force required to pierce the films of Comparative Examples 1 and 2.

Also included in Table 2 are the COF measurements. The COF of materials that are used in pallet stretch hoods is typically required to be greater than 0.3 and less than 0.8. The optimal value of the COF will depend on the design of the equipment used to stretch the film and apply the hood. More specifically, the optimal COF will be determined by the forces required to hold the film on the equipment and by the ease with which the film must be released from the equipment onto the loaded pallet. The data in Table 2 demonstrate that the compositions of the invention may be tailored to attain a broad range of COF values. The data also demonstrate that COF range attainable by the compositions of the invention advantageously coincides with the COF range that is typically specified for pallet stretch hood materials.

TABLE 3
Tensile Test Results

| | ε Total 90% | | ε Total 100% | | ε Total 110% | | ε Total 120% | |
|---|---|---|---|---|---|---|---|---|
| | Fε | | Fε | | Fε | | Fε | |
| | Total, | FRV*, | Total, | FRV*, | Total, | FRV*, | Total, | FRV*, |
| Example No. | mPa | Mpa | mPa | Mpa | mPa | Mpa | mPa | Mpa |
| Comparative 1 | 5.06 | 0.87 | 5.18 | 0.51 | 5.17 | 0.29 | n/a | n/a |
| 1 | 5.80 | 1.17 | 5.88 | 0.83 | 6.01 | 0.53 | 6.10 | 0.16 |
| Comparative 2 | 5.91 | 1.22 | 5.31 | 0.66 | 6.07 | 0.38 | n/a | n/a |
| 2 | 6.35 | 1.24 | 6.43 | 0.87 | 6.53 | 0.53 | 6.46 | 0.00 |

Notes:
*Force Reference Value, lower dwell time
“n/a” means “not available.”

The tensile test data summarized in Table 3 demonstrate that the Fε Total of the film of Comparative Example 1 is significantly less than the Fε Total of the film of Example 1 at every tested value of E Total. Moreover, the Force Reference Values of the film of Comparative Example 1 are significantly less than the Force Reference Value of the film of Example 1 at every tested value of ε Total. The Fε Total and Force Reference Values of the films of Comparative Example 2 and Example 2 stand in the same relationship.

These data therefore demonstrate that, after great elongation, the films according to the invention are capable of retaining a larger elastic force than is exerted by the films known in the art.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A polymer composition comprising
a polyolefin;
an ethylene vinyl acetate copolymer, an ethylene methyl acrylate copolymer, or a combination of an ethylene vinyl acetate copolymer and an ethylene methyl acrylate copolymer; and
a metallocene catalyzed polyethylene; and, optionally, an acid copolymer, provided that the acid copolymer is present in a finite amount when the amount of ethylene methyl acrylate copolymer is zero;
said polymer composition having at least one elastomeric feature.

2. The polymer composition of claim 1, comprising
a finite amount of the polyolefin up to about 80 wt % based on the total weight of the polymer composition;
a finite amount of the ethylene vinyl acetate copolymer, the ethylene methyl acrylate copolymer, or the combination of ethylene vinyl acetate copolymer and ethylene methyl acrylate copolymer up to about 80 wt % based on the total weight of the polymer composition;
a finite amount of metallocene catalyzed polyethylene up to about 30 wt % based on the total weight of the polymer composition; and,
when the amount of ethylene methyl acrylate copolymer is zero, a finite amount of the acid copolymer up to about 30 wt % based on the total weight of the polymer composition.

3. The polymer composition of claim 1, comprising
about 20 to about 70 wt % of the polyolefin, based on the total weight of the polymer composition;
about 20 to about 70 wt % of the ethylene vinyl acetate copolymer, the ethylene methyl acrylate copolymer, or the combination of ethylene vinyl acetate copolymer and ethylene methyl acrylate copolymer, based on the total weight of the polymer composition;
about 20 to about 70 wt % of the metallocene catalyzed polyethylene, based on the total weight of the polymer composition; and
when the amount of ethylene methyl acrylate copolymer is zero, about 5 to about 20 wt % of the acid copolymer based on the total weight of the polymer composition.

4. The polymer composition of claim 1, comprising
about 5 to about 15 wt % of the polyolefin based on the total weight of the polymer composition;
about 40 to about 60 wt % of the ethylene vinyl acetate copolymer, the ethylene methyl acrylate copolymer, or the combination of ethylene vinyl acetate copolymer and ethylene methyl acrylate copolymer, based on the total weight of the polymer composition;
about 40 to about 60 wt % of the metallocene catalyzed polyethylene, based on the total weight of the polymer composition; and,
when the amount of ethylene methyl acrylate copolymer is zero, about 5 to about 15 wt % of acid copolymer based on the total weight of the polymer composition.

5. The polymer composition of claim 1, wherein the polyolefin is an ethylene polymer.

6. The polymer composition of claim 5, wherein the polyolefin is an ethylene homopolymer or an ethylene interpolymer selected from the group consisting of low density polyethylene, heterogeneously branched ethylene/α-olefin interpolymer, ultra low density polyethylene, substantially linear ethylene polymers, and homogeneously branched ethylene polymers.

7. The polymer composition of claim 1, wherein the ethylene vinyl acetate copolymer comprises 10 wt % to 25 wt % of vinyl acetate comonomer residues.

8. The polymer composition of claim 7, wherein the ethylene vinyl acetate copolymer comprises 12 wt % to 18 wt % of vinyl acetate comonomer residues.

9. The polymer composition of claim 1, wherein the ethylene vinyl acetate copolymer has a melting point greater than about 80° C.

10. The polymer composition of claim 1, wherein the ethylene vinyl acetate copolymer has a melt flow index between 0.1 g/10 min and 10 g/10 min when measured according to ASTM D1238.

11. The polymer composition of claim 10, wherein the ethylene vinyl acetate copolymer has a melt flow index between 0.3 g/10 min and 1 g/10 min when measured according to ASTM D1238.

12. The polymer composition of claim 1, wherein the ethylene methyl acrylate copolymer is prepared in a tubular reactor.

13. The polymer composition of claim 1, wherein the ethylene methyl acrylate copolymer comprises more than 10 wt % of methyl acrylate comonomer, based on the weight of the ethylene methyl acrylate copolymer.

14. The polymer composition of claim 13, wherein the ethylene methyl acrylate copolymer comprises more than 25 wt % of methyl acrylate comonomer, based on the weight of the ethylene methyl acrylate copolymer.

15. The polymer composition of claim 1, wherein the ethylene methyl acrylate copolymer has a melt flow index less than 5 g/10 min when measured according to ASTM D1238.

16. The polymer composition of claim 15, wherein the ethylene methyl acrylate copolymer has a melt flow index less than 1 g/10 min when measured according to ASTM D1238.

17. The polymer composition of claim 1, wherein the metallocene catalyzed polyethylene has a melt flow index less than 2.5 g/10 min when measured according to ASTM D1238.

18. The polymer composition of claim 17, wherein the metallocene catalyzed polyethylene has a melt flow index less than 1.0 g/10 min when measured according to ASTM D1238.

19. The polymer composition of claim 18, wherein the metallocene catalyzed polyethylene has a melt flow index less than 0.5 g/10 min when measured according to ASTM D1238.

20. The polymer composition of claim 19, wherein the metallocene catalyzed polyethylene has a melt flow index less than 0.3 g/10 min when measured according to ASTM D1238.

21. The polymer composition of claim 1, wherein the acid copolymer is selected from the group consisting of ethylene/(meth)acrylic acid, ethylene/(meth)acrylic acid/n-butyl(meth)acrylate, ethylene/(meth)acrylic acid/iso-butyl(meth)acrylate, ethylene/(meth)acrylic acid/methyl(meth)acrylate, and ethylene/(meth)acrylic acid/ethyl(meth)acrylate.

22. An object comprising the polymer composition of claim 1.

23. A pallet stretch hood comprising the polymer composition of claim 1.

24. A method of increasing the elastic domain of a polymer blend, comprising the steps of:
providing a polyolefin and an ethylene vinyl acetate copolymer, an ethylene methyl acrylate copolymer, or a combination of an ethylene vinyl acetate copolymer and an ethylene methyl acrylate copolymer; and
blending the polyolefin and the ethylene vinyl acetate copolymer, the ethylene methyl acrylate copolymer, or the combination of ethylene vinyl acetate copolymer and ethylene methyl acrylate copolymer with a metallocene catalyzed polyethylene, and, optionally, an acid copolymer.
